(19) United States
(12) Patent Application Publication
(10) Pub. No.: US 2012/0154372 A1
(43) Pub. Date: Jun. 21, 2012

(54) TIMED READING EXPERIENCE ELECTRONIC BOOK

(75) Inventors: Brian Buck, Denver, CO (US); Hugh Griffith, Boise, ID (US); Adam Mock, Montgomery, IL (US); Helen A. Rosburg, Odessa, FL (US)

(73) Assignee: Medallion Press, Inc., West Palm Beach, FL (US)

(21) Appl. No.: 13/323,985

(22) Filed: Dec. 13, 2011

Related U.S. Application Data
(60) Provisional application No. 61/425,158, filed on Dec. 20, 2010.

(51) Int. Cl. G06F 17/00

(52) U.S. Cl. 345/418

(57) ABSTRACT

An electronic book (26) is provided. The electronic book (26) includes a first storyline (201) and at least a second storyline (202). The electronic book (26) further includes one or more time-based rules, which control an order of content displayed to a user from the first storyline (201) or the at least second storyline (202).

### RELATED APPLICATIONS

This application claims the benefit of U.S. provisional application No. 61/425,158 filed on Dec. 20, 2010 entitled “Electronic Book, Processing Systems, and Methods” which is hereby incorporated by reference into this application for all that it teaches.

### TECHNICAL FIELD

The embodiments described below relate to, electronic books, and more particularly, to an electronic book with a timed reading experience.

### BACKGROUND OF THE INVENTION

Electronic books (e-books) have become increasingly popular due in part to the convenience and accessibility associated with e-books and e-book readers. The recent improvement in software and hardware platforms for e-book readers has made it possible for users to download entire books in a matter of minutes from the convenience of their own home or at remote locations using cellular networks or third party wireless internet networks. Therefore, e-books allow a user to download the book without physically going to a book store. Early e-book readers, such as the Kindle® by Amazon® included software that was solely dedicated to e-book reading. This limited the number of users that utilized e-book readers as the device only performed an e-book reading function. However, with the advent of tablet computers, such as the iPad® by Apple® and other similar devices that include functions and features in addition to e-book reading, e-book reading has increased in popularity. The e-book readers generally provide a digital interface for a user that, in many ways, mimics the reading experience of a conventional paper bound book. However, e-book readers provide increased capabilities compared to paper bound books, such as highlighting text, saving portions of the text, adding notes, forwarding portions to another user, etc. Therefore, in many aspects, e-book readers can provide an enhanced reading experience.

Another advantage of e-books is the possibility to provide multiple endings to a book. For example, United States Patent Application Publication 2004/0003344 describes an e-book reader that can include one or more hyperlinks that allows a user to access an alternative ending to a book. However, the '344 application requires that the user actively choose the alternative ending. Consequently, such an approach takes much of the excitement and mystery out of the reading experience.

The embodiments described below disclose a system and method for providing a time-based reading experience with an e-book that includes one or more alternative storylines that are chosen as a function of time. The alternative storylines may be chosen as a function of absolute time or as a function of an average reading time, for example. Consequently, the selection of an alternative storyline does not require active participation by the user. In contrast, the user may not be aware that the storyline being read has diverted away from a main storyline. This approach leaves the reader with an improved reading experience. As can be appreciated, as the reader is generally unaware of when an alternative storyline is taken, such an experience is unavailable in conventional paper book reading and has not been utilized in prior art e-books.

### SUMMARY OF THE INVENTION

An electronic book is provided according to an embodiment. The electronic book comprises a first storyline and at least a second storyline. According to an embodiment, the electronic book further comprises one or more time-based rules. The time-based rules control an order of content displayed to a user from the first storyline or the at least second storyline.

A method for defining content of an electronic book to be displayed is provided according to an embodiment. The method comprises determining if a page of content includes a time-based rule. According to an embodiment, if the page of content does include a time-based rule, the method processes the time-based rule. According to an embodiment, the method further defines a page of content to be displayed based on the outcome of the processed time-based rule.

A software application stored in a non-transitory medium is provided according to an embodiment. According to an embodiment, the software application defines content of an electronic book to be displayed. The software application is configured to determine if a page of content includes a time-based rule. According to an embodiment, if the page of content does include a time-based rule, the software application is further configured to process the time-based rule. According to an embodiment, the software application is further configured to define a page of content to be displayed based on the outcome of the processed time-based rule.

An electronic book reader is provided according to an embodiment. The electronic book reader comprises an interface and a storage system including at least one electronic book and a software application for processing one or more time-based rules for the at least one electronic book. According to an embodiment, the electronic book reader further comprises a processing system configured to process the one or more time-based rules and display content of the at least one electronic book.

A method for incorporating one or more time-based rules into an electronic book is provided according to an embodiment. The method comprises retrieving an electronic book file and inserting a rule start marking point for a time-based rule in the electronic book file. According to an embodiment, the method further comprises inserting a rule injection point for the time-based rule in the electronic book file.

### ASPECTS

According to an aspect an electronic book comprises:
a first storyline and at least a second storyline; and
one or more time-based rules, which control an order of content displayed to a user from the first storyline or the at least second storyline.

Preferably, the one or more time-based rules are embedded at predetermined locations in the first and at least second storylines.

Preferably, a time-based rule of the one or more time-based rules comprises:
a start marking point to begin tracking time; and
an injection point to end tracking time and process the time-based rule.

Preferably, the time-based rule is based on an absolute differential time between the start marking point and the injection point.

Preferably, the time-based rule is based on an average reading time between the start marking point and the injection point.

Preferably, the time-based rule is based on an instant time.

Preferably, the electronic book further comprises one or more exceptions that can prevent processing of the one or more time-based rules.

According to another aspect, a method for defining content of an electronic book to be displayed comprises:
determining if a page of content includes a time-based rule;
if the page of content does include a time-based rule, process the time-based rule; and
defining a page of content to be displayed based on the outcome of the processed time-based rule.

Preferably, the page of content to be displayed comprises the same page of content including the time-based rule.

Preferably, the page of content to be displayed comprises a page different from the page of content including the time-based rule.

Preferably, processing the time-based rule comprises:
determining an absolute differential time between two pages of content; and
comparing the determined absolute differential time to a threshold value or range.

Preferably, a first new page of content is defined if the determined absolute differential time is within the threshold value or range or a second new page of content is defined if the determined absolute differential time exceeds the threshold value or range.

Preferably, the first new page corresponds to a next logical page of a current storyline and the second new page corresponds to a next logical page of an alternative storyline.

Preferably, processing the time-based rule comprises:
determining an instant time; and
comparing the instant time to a threshold value or range.

Preferably, a first new page of content is defined if the determined instant time is within the threshold value or range and a second new page of content is defined if the determined instant time exceeds the threshold value or range.

Preferably, the first new page corresponds to a next logical page of a current storyline and the second new page corresponds to a next logical page of an alternative storyline.

Preferably, processing the time-based rule comprises:
determining an average reading time; and
comparing the average reading time to a threshold value or range.

Preferably, the average reading time is determined from a group comprising: a user input, an assumed reading time based on one or more of the user's characteristics, an assumed reading time based on an intended reading audience of the electronic book, and a calculated reading time based a time for a user to turn a page of the electronic book.

Preferably, a first new page of content is defined if the determined average reading time is within the threshold value or range or a second new page of content is defined if the determined average reading time exceeds the threshold value or range.

Preferably, the first new page corresponds to a next logical page of a current storyline and the second new page corresponds to a next logical page of an alternative storyline.

According to another aspect, a software application stored in a non-transitory medium for defining content of an electronic book to be displayed and is configured to:
determine if a page of content includes a time-based rule;
if the page of content does include a time-based rule, process the time-based rule; and
define a page of content to be displayed based on the outcome of the processed time-based rule.

Preferably, the page of content to be displayed comprises the same page of content including the time-based rule.

Preferably, the page of content to be displayed comprises a page different from the page of content including the time-based rule.

Preferably, the software application is further configured to:
determining an absolute differential time between two pages of content; and
comparing the determined absolute differential time to a threshold value or range.

Preferably, a first new page of content is defined if the determined absolute differential time is within the threshold value or range or a second new page of content is defined if the determined absolute differential time exceeds the threshold value or range.

Preferably, the first new page corresponds to a next logical page of a current storyline and the second new page corresponds to a next logical page of an alternative storyline.

Preferably, the software application is further configured to:
determine an instant time; and
compare the instant time to a threshold value or range.

Preferably, a first new page of content is defined if the determined instant time is within the threshold value or range and a second new page of content is defined if the determined instant time exceeds the threshold value or range.

Preferably, the first new page corresponds to a next logical page of a current storyline and the second new page corresponds to a next logical page of an alternative storyline.

Preferably, the software application is further configured to:
determine an average reading time; and
compare the average reading time to a threshold value or range.

Preferably, the average reading time is determined from a group comprising: a user input, an assumed reading time based on one or more of the user's characteristics, an assumed reading time based on an intended reading audience of the electronic book, and a calculated reading time based a time for a user to turn a page of the electronic book.

Preferably, a first new page of content is defined if the determined average reading time is within the threshold value or range or a second new page of content is defined if the determined average reading time exceeds the threshold value or range.

Preferably, the first new page corresponds to a next logical page of a current storyline and the second new page corresponds to a next logical page of an alternative storyline.

According to another aspect, an electronic book reader comprises:
an interface;
a storage system including at least one electronic book and a software application for processing one or more time-based rules for the a least one electronic book; and
a processing system configured to process the one or more time-based rules and display content of the at least one electronic book.

Preferably, the page of displayed content comprises the same page of content including the time-based rule.

Preferably, the page of displayed content comprises a page different from the page of content including the time-based rule.

Preferably, the processing system is further configured to:
determine an absolute differential time between two pages of displayed content; and
compare the determined absolute differential time to a threshold value or range.

Preferably, a first new page of content is displayed on the interface if the determined absolute differential time is within the threshold value or range or a second new page of content is displayed on the interface if the determined absolute differential time exceeds the threshold value or range.

Preferably, the first new page corresponds to a next logical page of a current storyline and the second new page corresponds to a next logical page of an alternative storyline.

Preferably, the processing system is further configured to:
determine an instant time; and
compare the instant time to a threshold value or range.

Preferably, a first new page of content is defined if the determined instant time is within the threshold value or range and a second new page of content is defined if the determined instant time exceeds the threshold value or range.

Preferably, the first new page corresponds to a next logical page of a current storyline and the second new page corresponds to a next logical page of an alternative storyline.

Preferably, the processing system is further configured to:
determine an average reading time; and
compare the average reading time to a threshold value or range.

Preferably, the average reading time is determined from a group comprising: a user input, an assumed reading time based on one or more of the user's characteristics, an assumed reading time based on an intended reading audience of the electronic book, and a calculated reading time based a time for a user to turn a page of the electronic book.

Preferably, the processing system is further configured to display a first new page of content if the determined average reading time is within the threshold value or range and display a second new page of content if the determined average reading time exceeds the threshold value or range.

Preferably, the first new page corresponds to a next logical page of a current storyline and the second new page corresponds to a next logical page of an alternative storyline.

According to another aspect, a method for incorporating one or more time-based rules into an electronic book comprises:
retrieving an electronic book file;
inserting a rule start marking point for a time-based rule in the electronic book file; and
inserting a rule injection point for the time-based rule in the electronic book file.

Preferably, the time-based rule is based on an absolute differential time between the start marking point location and the injection point location.

Preferably, the method further comprises:
instructing a first page of content of the electronic book to be displayed if the absolute time between the start marking point location and the injection point location is within a threshold value or range; and
instructing a second page of content to be displayed if the absolute time between the start marking point location and the injection point location is outside the threshold value or range.

Preferably, the first page of content comprises a first storyline and the second page of content comprises a second storyline.

Preferably, the time-based rule is based on an instant time.

Preferably, the method further comprises:
instructing a first page of content of the electronic book to be displayed if the instant time is within a threshold value or range; and
instructing a second page of content to be displayed if the instant time is outside the threshold value or range.

Preferably, the first page of content comprises a first storyline and the second page of content comprises a second storyline.

Preferably, the time-based rule is based on an average reading time between the start marking point location and the injection point location.

Preferably, the determined course of action comprises:
instructing a first page of content of the electronic book to be displayed if the average reading time between the start marking point location and the injection point location is within a threshold value or range; and
instructing a second page of content to be displayed if the average reading time between the start marking point location and the injection point location is outside the threshold value or range.

Preferably, the first page of content comprises a first storyline and the second page of content comprises a second storyline.

### BRIEF DESCRIPTION OF THE DRAWINGS

FIG. 1 shows an e-book reader according to an embodiment.

FIG. 2 shows a flow chart of an e-book including multiple alternative storylines according to an embodiment.

FIG. 3 shows a reader's path through an e-book including multiple alternative storylines according to an embodiment.

FIG. 4 shows a method for providing an e-book with one or more time-based rules according to an embodiment.

FIG. 5 shows a processing routine according to an embodiment.

### DETAILED DESCRIPTION OF THE INVENTION

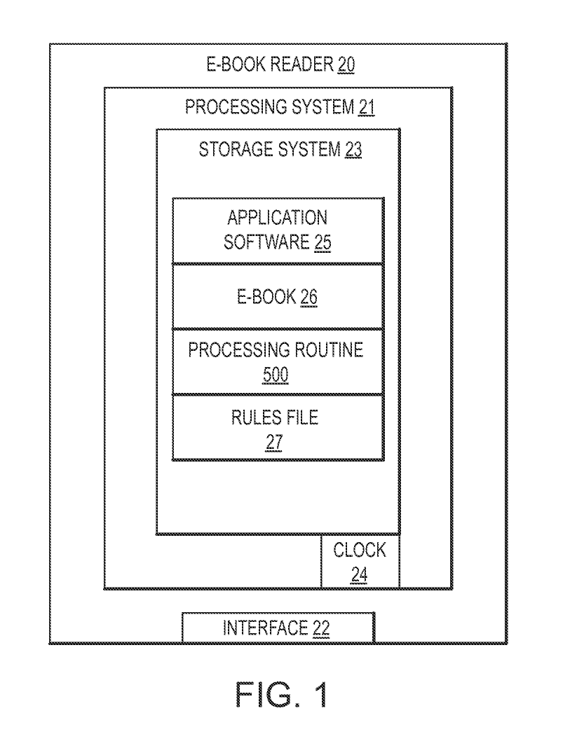

FIGS. 1-5 and the following description depict specific examples to teach those skilled in the art how to make and use the best mode of embodiments of an electronic book. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the electronic book. As a result, the embodiments described below are not limited to the specific examples described below, but only by the claims and their equivalents.

FIG. 1 shows an exemplary e-book reader 20. The e-book reader 20 may comprise any one of the many well-known e-book readers available and is provided merely as an example and to aid the reader in understanding the embodiments described below. According to an embodiment, the e-book reader 20 may comprise a standalone device dedicated to e-book reading. Alternatively, e-book reading may comprise just one of many other functions that can be performed by the e-book reader 20. For example, the e-book reader 20 may comprise a tablet computer, a desktop computer, a laptop computer, etc. The e-book reader 20 may comprise any device capable of executing software and/or hardware in order to display text and/or illustrations (content) to a user. The content may comprise a portion of an e-book, for example.

The e-book reader 20 comprises a processing system 21, an interface 22, and a storage system 23. The e-book 20 can further include a clock or timer 24, which is discussed in more detail below. The processing system 21 can be configured to execute various routines using one or more computer programs, such as the software application 25 stored in the storage system 23. The software application 25 can be utilized in processing and defining content of a stored e-book 26 to be displayed to a user. The software application 25 may be used by the processing system 21 to process one or more time-based rules embedded in an e-book 26 and define predetermined content to be displayed on the interface 22 based on the processed rules. In other embodiments, the software application 25 may be used by the processing system 21 to process one or more time-based rules provided as a separate rule file 27 accessed while a user is reading the e-book 26. Although a single e-book 26 is shown, those skilled in the art will readily recognize that the e-book reader 20 may store numerous e-books simultaneously, which can be retrieved for viewing. It should be appreciated that in some embodiments, the software application 25 for processing e-books may comprise substantially the only software application loaded on the e-book reader 20. Thus, the e-book reader 20 may be a designated e-book reader that does not generally perform other functions, such as email, surfing the web, etc. An example would be the Kindle® by Amazon®. Alternatively, the software application 25 for processing e-books may comprise one of many applications stored on the e-book reader, for example, the iPad® by Apple®.

According to an embodiment, the interface 22 may comprise a touch screen display or the like that allows the user to interact with and display a selected e-book. The interface 22 may comprise an integral portion of the e-book reader 20. Alternatively, the interface 22 may be located remotely from the e-book reader 20, such as in a desktop computer. The interface 26 may additionally include discrete push buttons for selecting various actions to be performed by the processing system 21.

The various functions of the e-book reader 20 will become apparent based on the description that follows as well as a basic understanding of available e-book readers by those skilled in the art.

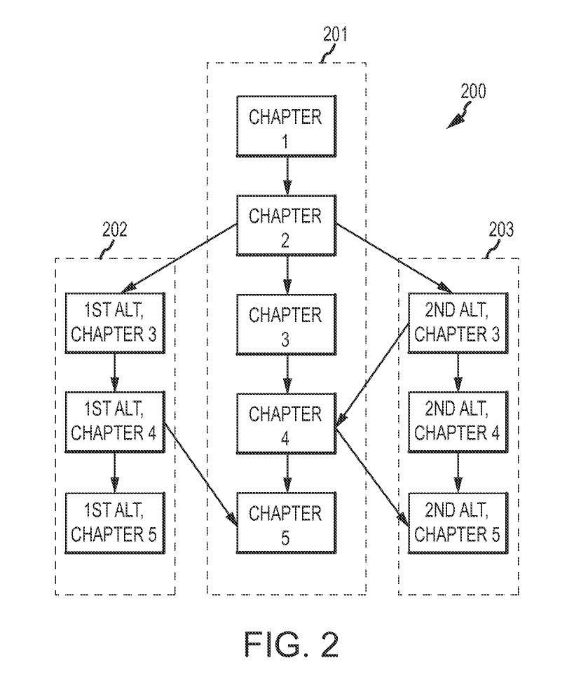

According to an embodiment, the e-book 26 may comprise one or more storylines. For example, the e-book may comprise a main storyline and one more alternate storylines that are selectively displayed on the interface 22 based on the outcome of one or more rules embedded in the e-book 26 and processed using the processing system 21 and the software application 25. Therefore, the time-based rules can control an order of content being displayed to user from the one or more storylines. As can be appreciated, the e-book 26 can comprise a readily acceptable e-book format. This allows the e-book 26 to be read by an e-book reader that does not include the software application 25 capable of processing time-based rules. Those skilled in the art will readily recognize that if the e-book 26 is being read by an e-book reader that does not include the software application 25 required to process the various time-based rules, the e-book reader will simply display the main storyline and the alternate storylines may not be available for display. Therefore, according to an embodiment, the e-book reader 20 should be configured to process one or more rules provided in the e-book 26 in order to access the one or more alternative storylines. An example of a flow chart of an e-book including multiple alternative storylines is provided in FIG. 2.

FIG. 2 shows a flow chart 200 of an e-book including multiple alternative storylines 201-203 according to an embodiment. The e-book may be provided in an acceptable e-book format that is used to create, edit, or publish readable content for an e-book reader. Some common e-book formats include, but are not limited to EPUB, plain text files, HTML, PDF, eReader, Newton eBook, and iPod Notes. Other e-book formats are known that perform similar functions as the above-mentioned formats. Therefore, the e-book 26 can be read on various e-book readers, which are known in the art. However, as mentioned above, according to an embodiment, the e-book reader may require the additional software application 25 to process one or more time-based rules in order to provide the user with multiple alternative storylines. The one or more time-based rules may be embedded within the e-book 26 as meta-data at predetermined locations in the various storylines 201-203, for example. According to another embodiment, the one or more time-based rules may be provided as a separate file, such as the rules file 27.

According to an embodiment, the e-book 26 may diverge from a main storyline and proceed with one or more alternative storylines; or at least a portion of an alternative storylines, based on the processing of one or more time-based rules, for example. In FIG. 2, the main storyline 201 extends down the center of FIG. 2 with chapters 1-5. It should be appreciated, that five chapters are shown merely as an example and should in no way limit the scope of the description and claims. A first alternative storyline 202 is shown and includes a first alternate chapter 3, a first alternate chapter 4, and a first alternate chapter 5. Similarly, a second alternative storyline 203 is shown and includes a second alternate chapter 3, a second alternate chapter 4, and a second alternate chapter 5. According to an embodiment, the various alternative storylines can be substituted for the main storyline 201 based on one or more embedded time-based rules that are processed by the application software 25. Because the embedded rules are time-based rather than user selectable, a user may not be aware that an alternative storyline is being displayed by the e-book reader. Likewise, the user does not need to actively select an alternative storyline. Rather, the alternative storyline is automatically selected by the processing system 21 based on the outcome of the processed time-based rules. Advantageously, the user is not interrupted during a divergence from one storyline to another.

According to the embodiment shown in FIG. 2, the flow chart 200 of the e-book starts with chapter 1, which is part of the main storyline 201 and proceeds to chapter 2. In the embodiment shown, chapter 2 includes one or more “time-based rules”, which the e-reader 20 can process in order to display a specific storyline of the e-book. According to an embodiment, if a first rule is satisfied, the e-book proceeds to the first alternative chapter 3. Conversely, if a second rule is met, the e-book proceeds to a second alternative chapter 3. According to the embodiment shown, if neither rule is satisfied, the e-book 26 continues down the main storyline to chapter 3. As shown in the flow chart, the e-book 26 may exit and enter the main storyline 201 multiple times throughout the user's reading of the e-book 26 as the user is directed towards various portions of the first and/or second alternative storylines 202, 203. Although the flow chart 200 shows the alternative storylines diverting from the main storyline 201 at the end of a given chapter, it should be appreciated, that a storyline may likewise diverge away from a main storyline at any desired point of the e-book. Therefore, the described embodiment should not be limited to diverging from a current storyline at the end of a chapter of the e-book 26.

As discussed above, the e-book 26 may divert from one storyline to another based on the processing of one or more predetermined time-based rules. According to an embodiment, the time-based rule may be based on an absolute time. More specifically, the time-based rule may be based on a difference between two absolute times. The absolute time can be determined using the e-book reader's internal clock 24, for example. According to one embodiment, the absolute time can include a Greenwich Mean Time (GMT) offset that can account for changes in the local time in the event a user changes time zones while reading the e-book 26. According to an embodiment, the absolute time may continue to elapse after the e-book 26 has been closed. Therefore, the absolute time can be utilized to keep track of an ongoing total time of the e-book 26. Therefore, in some embodiments, the actual time may not be of interest, but rather, the absolute difference in times between two points may be of interest. In such a case, the clock 24 may simply comprise a timer that can continuously track an absolute differential time, such as a timer. However, because the absolute differential time should continue to be tracked even after the e-book is closed, in many embodiments, it is easier to utilize the e-book reader' s internal clock 24 to determine a total elapsed time taken for the user to reach two different points of the e-book 26. The use of the absolute time is discussed in greater detail below.

According to another embodiment, a time-based rule may be based on an average reading time. According to an embodiment, the average reading time may only be tracked while the e-book 26 is being displayed to the user, and thus, the processing system 21 assumes the e-book 26 is being read. This is in contrast to the absolute time that is tracked even after the e-book 26 is closed by the user.

According to an embodiment, the average reading time may be determined based on an accumulated time between “page” turns. A “page” may comprise a set of content that is viewable at one time on the display of the e-reader 20. However, those skilled in the art can readily appreciate that the specific content viewable on a given “page” may vary from one e-book reader 20 to another based on many factors including, screen size, font size, font style, etc. Therefore, while the use of page is used to aid the reader in understanding the embodiments described, a page should in no way be limited to content that is viewable on a specific e-book reader. For example, the processing system 21 may determine how many words are on a displayed page. From the number of words displayed along with the time taken to turn the page, an average number of words per minute read by the user can be determined.

According to another embodiment, an average reading time can be assumed. The assumed average reading time can be based on one or more user characteristics, such as a user's age, gender, education level, nationality, etc. A user may alternatively input an average reading time, such as an assumed words read per minute. According to another embodiment, an average reading time can be assumed based on the intended reading audience of the e-book. For example, the processing system 21 may assume a lower number of words per minute for a children's book than for an adult novel. Alternatively, the e-book may provide the processing system 21 with an assumed number of words per minute predetermined by the publisher or supplier, for example. The assumed number of words per minute may be provided with the e-book and embedded as part of a rule, for example.

According to another embodiment, the average reading time may be determined during the first one or two pages read by the user. Alternatively, a rolling average reading time may be implemented wherein the average reading time is updated as the user reads the e-book 26. The average reading time may be updated every page, every chapter, etc.

According to yet another embodiment, the time-based rule may be based on an instant time. For example, the instant time may comprise a specific date. According to an embodiment, the specific date may change based on a user's input. For example, the specific date may comprise the user's birthday, anniversary, subscription renewal date, etc. Alternatively, the instant time may comprise a specific time. The instant time may include a GMT offset similar to the offset used with the absolute time-based rule.

In addition to the types of time used to base rules upon, the e-book 26 may also include various types of rules. According to an embodiment, a rule may comprise a so-called “discrete” rule, which is stand alone and does not depend upon prior rules or directly impact future rules. Alternatively, a rule may comprise a chained rule whereby the processing of the rule is dependent on the results of rules linked to the currently processed rule.

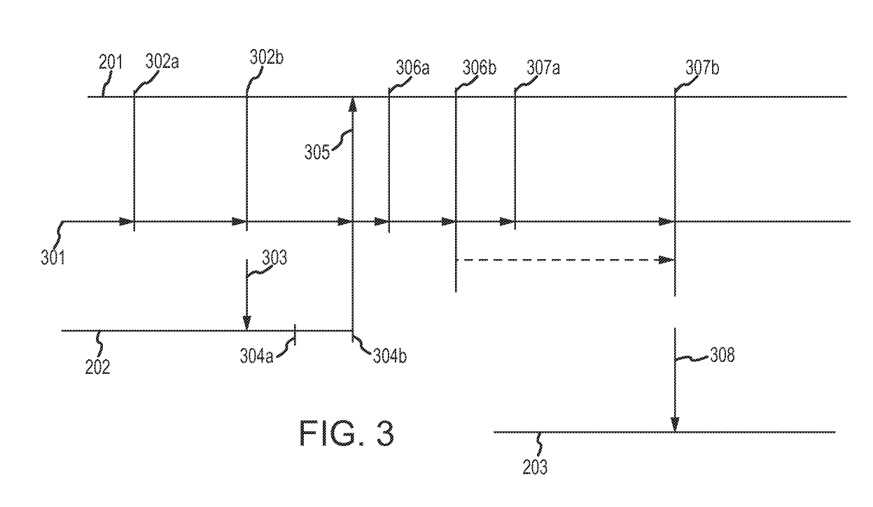

FIG. 3 shows a reader's path through the e-book 26 including the multiple alternative storylines as various rules are encountered according to an embodiment. According to the embodiment shown in FIG. 3, a user can progress down a reader's path 301 while reading the e-book 26. At a predetermined point, a time-based rule 302 is encountered. A first portion of the time-based rule 302 comprises a start marking point 302a. The predetermined point may comprise the beginning or end of a page of content. The page of content may be currently displayed or may comprise the next logical page of content to be displayed. For example, the start marking point 302a may occur as soon as a user requests that a predetermined page be displayed. According to an embodiment, the start marking point 302a is the point or position in the e-book content where a rule starts time calculations. Therefore, the rule is not actually evaluated at the start marking point 302a, i.e., an outcome is not decided. As discussed above, the time calculations may comprise an absolute time or an average reading time. If the start marking point 302a indicates that the time calculation for the first rule comprises an absolute time, the absolute time as provided by the e-book reader's clock 24 can be recorded and stored for later processing. According to an embodiment, the local time reported by the e-book reader's clock 24 may be offset to GMT. If on the other hand, the start marking point 302a indicates that the first rule is based on an average reading time, the average reading time can be determined or the processing system 21 can begin tracking the user's average reading time.

According to an embodiment, at some predetermined position in the e-book contents, an injection point 302b for the first rule is provided. The injection point 302b will be after the start marking point 302a. According to an embodiment, the injection point 302b comprises the location or position in the e-book contents where the rule's condition is evaluated. The position may comprise the end of a predetermined page, for example. According to an embodiment, the rule's condition is evaluated at the injection point 302b to determine if the time is within a threshold value or range. For example, if the injection point 302b is at the end of a page, the rule's condition can be evaluated prior to displaying the next page. As can be appreciated, if the time-based rule is based on an instant time, the start marking point and the injection point will occur simultaneously.

According to an embodiment, the processing system 21 can determine if the time is within a threshold value or range. If the rule is based on an absolute time, the processing system 21, using the software application 25, can determine the absolute time when the injection point is reached. The absolute time the injection point 302b is reached can be compared to the absolute time the start marking point 302a was encountered. The comparison can provide a total elapsed time between points 302a and 302b. As can be appreciated, the user may have been reading from the start marking point 302a to the injection point 302b. However, the user may have turned off the e-book for some amount of time. However, the absolute time continues to elapse even when the e-book 26 is turned off. Therefore, the processing system 21 can determine an absolute time difference between the start marking point and the injection point. This differential time can be compared to a predetermined threshold differential time while processing the first rule. For example, if the measured differential time is within the threshold value or range, the e-book reader 20 may display a first new page of content. In one embodiment, the first new page of content may comprise the next logical page of the main storyline 201. Alternatively, if the measured differential time is outside the threshold value or range, the e-book reader 20 may display a second new page of content. According to an embodiment, the second new page of content may comprise an alternative storyline 202, for example as shown by 303.

If the reader is directed towards the first alternative storyline 202 based on the outcome of the time-based rule, one or more additional rules may be encountered during further portions of the e-book 26 and processed by the processing system 21. For example, the first alternative storyline 202 is shown with a second start marking point 304a corresponding to a second rule 304. Likewise, a second injection point 304b is shown corresponding to the second rule 304.

According to an embodiment, the second encountered rule may be based on an absolute time, and instant time, or an average reading time. The second encountered rule is based on an average reading time in the example provided. For example, once the start marking point 304a is encountered, the processing system 21 may begin to track the average reading time of the user until the second injection point 304b. According to one embodiment, if the average reading time determined is within a threshold limit or range, a first new page of content may be displayed and if the average reading time is outside of the threshold limit or range, a different page of content can be displayed. For example, the first new page may continue with the storyline while second new page may diverge back to the main storyline 201, as shown by 305, for example. According to an embodiment, the threshold limit or range that the determined average reading time is compared to may comprise an initial average reading time determined at the beginning of the user's read of the e-book. Alternatively, as discussed above, the initial average reading time may comprise the assumed average read time as determined according to one of the examples provided above. Therefore, the second rule can essentially determine if the user has stayed on pace with their average reading time.

As can be appreciated, while the start marking point 304a is shown as being encountered during the user's reading of the first alternative storyline 202, in other embodiments, the start marking point 304a may be positioned in other locations. For example, the start marking point 304a may be located at the beginning of the e-book. As an example, the user's average reading time may be tracked from the time the e-book 26 is opened and then once the user reaches the second injection point 304b, the processing system 21 can execute the rule. The execution may comprise comparing the user's average reading time to an assumed reading time, for example. Therefore, if the user's average reading time is outside the assumed reading time by a threshold value or range, the processing system 21 can display the page corresponding to the failed rule.

If the processing system 21 directs the e-book back to the main storyline 201, a third rule is shown in FIG. 3. For example, FIG. 3 shows a start marking point 306a for the third rule and an injection point 306b for the third rule. The third rule 306 may be based upon an absolute time, an instant time, or an average reading time. For example, if the third rule 306 is based on an instant time, the processing system 21 may determine an instant time from the timer 24 and compare the instant time from the timer 24 to the instant time provided by the third rule 306. As an example, the instant time provided by the third rule 306 may be January 1^{st}. If timer 24 indicates that the instant date is January 1^{st}, the rule may pass and a predetermined page of content can be displayed. In some embodiments, the instant rule may be provided with a threshold value or range. For example, the third rule 306 may pass if the instant time indicated by the timer 24 is within a predetermined number of days, hours, minutes, seconds, etc. of the instant time provided by the rule.

The third rule 306 differs from the first two rules in that the third rule is chained to a fourth rule 307. The fourth rule 307 comprises a start marking point 307a and an injection point 307b. The fourth rule 307 may be based upon an absolute time, an instant time, or an average reading time. However, processing of the fourth rule is dependent upon the outcome of the third rule 306.

As an example, if the third rule 306 is not met, but the fourth rule is met, the associated course of action taken upon satisfying the fourth rule 307 will not occur. Therefore, if upon meeting the fourth rule 307, the processing system 21 is supposed to divert the e-book 26 to the second alternative storyline 203, if the third rule 306 is not met, the processing system 26 will maintain the e-book on the main storyline 201. Similarly, if the third rule 306 is satisfied, but the fourth rule 307 is not satisfied, the processing system 26 will maintain the e-book on the main storyline 201. However, if both rules are satisfied, the action can be executed, in this case diverting to the second alternative storyline 203 as shown by 308. Therefore, in the above example, the third rule's injection point 306b can be considered a checkpoint. The checkpoint does not send the reader to an alternative storyline, but rather simply makes a time calculation based upon the rule's mode (absolute time, instant time, or average reading time) and allows the next rule in the chain to be processed.

According to an embodiment, the e-book 26 may include various exceptions to rule processing that the processing system 21 and the software application 25 can take into account when processing a rule. According to one embodiment, rules encountered on various pages may not be processed if the average reading time exceeds a predetermined threshold. For example, the threshold may be set to a level that assumes the user is not actually reading, but rather “thumbing” through the pages if the predetermined threshold is exceeded. In such a situation, the rules may not be processed.

According to another embodiment, another exception to the rule processing may occur if more than one rule is encountered on a single page. According to an embodiment, the rules are processed prior to displaying the next page. Therefore, if a page includes more than one rule, the processing system 21 may be configured to process the rules based upon a hierarchy. For example, the processing system 21 may only process the last (most recently encountered) rule on the page. Therefore, other rules may be ignored in some embodiments.

Another exception may be used if a page is re-read. It is not uncommon for a user to return to a previously read section of an e-book. For example, if the user determines that a certain passage was important. The re-read page may include a rule that has already been processed. According to an embodiment, the software application 25 may be configured to direct the processing system 21 to ignore rules that have already been processed. This prevents the user from being directed partially down one storyline and then suddenly being redirected down another storyline.

In some embodiments, the e-book reader 20 may be configured to display all of the storylines of the e-book 26 upon a user finishing the e-book, regardless of what storyline the user finally finishes. In some embodiments, the e-book reader 20 may display the storyline path that the user actually read along with the alternative storylines that were not read by the user. The user may have the option to select and read any of the unread storylines, which effectively turns off the rule processing. Alternatively, the user may reset the e-book to begin as if the e-book was never read. This may allow the user the opportunity to encounter different storylines based upon an updated absolute time and/or average reading time.

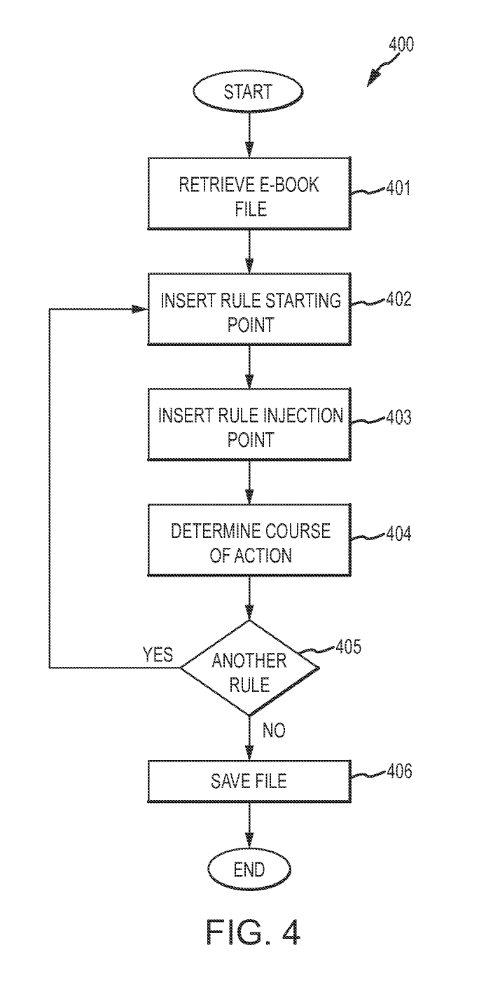

The embodiments described above include e-books that have rules embedded in their file. FIG. 4 below illustrates one example of how a publisher, author, or the like can implement rules that are later processed for an e-book.

FIG. 4 shows a method 400 for integrating one or more rules into an e-book, such as the e-book 26. The method 400 may be performed by a publisher, an author, or the like. The method 400 can be used to create an e-book with multiple alternative storylines that are time-based.

According to an embodiment, the method 400 starts in step 401 where an e-book file is retrieved. The e-book file may comprise a single storyline or more than one storyline, for example.

In step 402, a location for a rule's start marking point is selected. The start marking point location may comprise the end of a chapter, for example. Alternatively, the location may comprise the end of a page in the middle of a chapter. It should be appreciated, that while “page” is used, in actuality, the location of the rule is actually selected after a specific word as the precise number of words on a displayed “page” may differ from one e-book reader to another based on the selected font size, screen size, etc. The rule's start marking point is then inserted at the selected location.

In step 403, a location for the rule's injection point is selected. As mentioned above, the rule's injection point can comprise the location in the e-book where the rule can be processed. Once selected, the rule's injection point is inserted into the e-book file. The rule's injection point also determines a course of action that is taken upon processing the rule. The desired course of action may comprise what type of rule is implemented, what time basis will be used (absolute, instant, or average reading time), whether the rule will be chained to another rule or comprise a discrete rule, threshold value or ranges for comparing the determined time to. For example, the user of the method 400 can determine if the rule will decide if an alternate storyline will be displayed or whether the rule is merely a checkpoint for a chained rule.

The determined course of action may also include defining exceptions to processing the rule as discussed above.

Once the injection point for the rule is inserted, the method proceeds to step 404 where it is decided whether another rule will be incorporated into the e-book. If another rule is to be implemented, the process returns to step 402. If there is no other rule, the process proceeds to step 405 where the e-book file is saved for later editing, retrieval, downloading, etc.

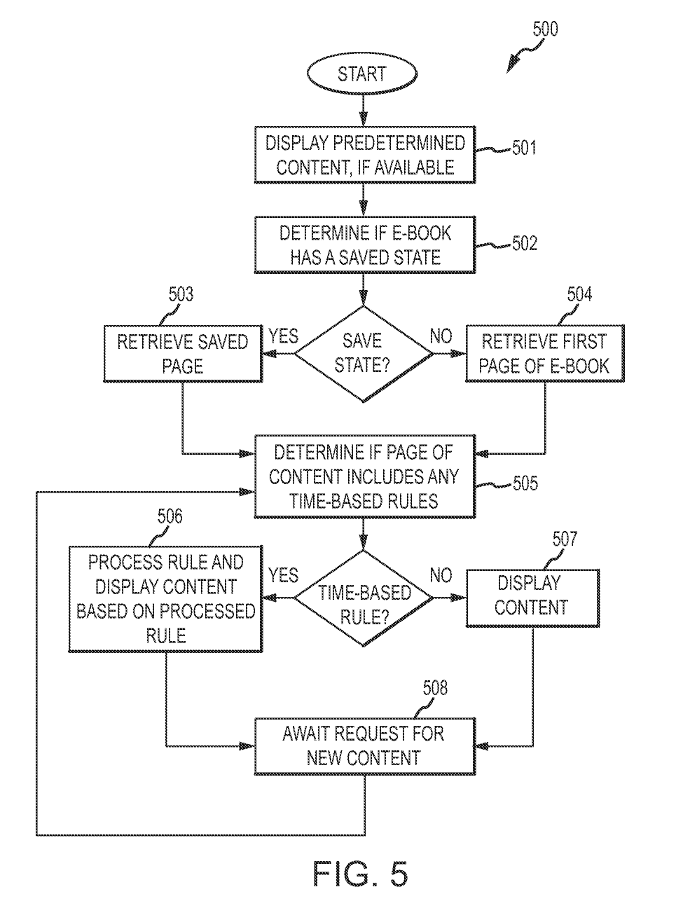

The above description has provided an overview of the timed reading experience e-book. As discussed above, when a user opens an e-book on the e-book reader 20, the processing system 21 utilizes the software application 25 to process various rules and display content to the user through the interface 22. FIG. 5 illustrates an exemplary processing routine 500 that can be used by the e-book reader 20 to process and display the e-book 26 to the user.

FIG. 5 shows a processing routine 500 according to an embodiment. The processing routine 500 may be utilized by the e-book reader 20, and more specifically, the processing system 21 in combination with the software application 25 to process various time-based rules and display content of the e-book 26 to the user according to the processing of the time-based rules. According to an embodiment, the processing routine 500 may comprise a portion of the software application 25 or may comprise a separate component saved in the storage system 21 of the e-book reader 20. Likewise, while the rules file 27 is shown as comprising a separate file from the e-book 26, in other embodiments, the rules file 27 may be embedded within the e-book 26 and provided along with the e-book 26.

According to an embodiment, the processing routine 500 can be implemented when a user launches a selected e-book, such as the e-book 26.

According to an embodiment, the processing routine 500 starts in step 501 where the processing system 21 can determine if any predetermined content is to be displayed. The predetermined content may comprise an advertisement, an e-reader logo, a welcome message, etc. Alternatively, the predetermined content may request a user to input certain information, for example, the user's age, gender, assumed reading speed, etc. In some embodiments, the predetermined content may not comprise a portion of the e-book 26. If there is no predetermined content available, the processing routine 500 can proceed to step 502 where the processing system 21 can determine if the selected e-book has a saved state. For example, the processing system 21 can determine if the selected e-book has been previously opened. If the e-book has a saved state, the saved state can be restored in step 503.

According to an embodiment, restoring the saved state can comprise retrieving the saved page, which was previously displayed, for further processing. It should be appreciated, that simply retrieving the saved page may not comprise displaying the saved page to the user.

According to an embodiment, if the e-book did not have a saved state, the processing system 21 can continue to step 504 where a first page of the e-book 26 is retrieved. The first page may comprise the table of contents, a front cover, a first page of the first chapter, etc.

Once the appropriate content is retrieved, the processing routine 500 can proceed to step 505, where the processing system 21 can determine if the retrieved page of content includes any time-based rules. The rules may be retrieved from the rules file 27, for example. If the page of content includes rules, for example, the processing system 21 can use the software application 25 to execute the necessary steps to process the rules in step 506 and display the appropriate page of content based on the processed rule. For example, the software application 25 can define the content that is to be displayed by the interface 22. For example, if the retrieved page of content comprises “page 10”, which contains a time-based rule, the processing system 21 can determine if “page 10” should be displayed or if “alternate page 10” should be displayed based on the processing of the time-based rule. Step 506 may comprise simply determining the absolute time, for example, if the rule for the page of content comprises a start marking point for an absolute time-based rule. Alternatively, step 506 may comprise determining the current absolute time and comparing the current absolute time to a previously determined time, such as in the case for an injection point for an absolute time-based rule. According to another embodiment, step 506 may comprise determining an average reading time and comparing the average reading time to a predetermined threshold value or range. As another alternative, step 506 may comprise determining an instant time and comparing the instant time to a threshold value or range. Step 506 may comprise any of the above-mentioned processing steps that the processing system 21 may perform upon encountering a start marking point or injection point of a time-based rule.

According to an embodiment, the processing routine can also display the appropriate content based on the time-based rule that is processed in step 506. The content displayed may comprise the content defined by the software application 25 and processed by the processing system 21, for example. The content to be displayed may depend upon whether the differential time, instant time, or average reading time is within a threshold value or limit. If the differential time, instant time, or average reading time is within a threshold value or limit, a first new page of content may be displayed. For example, in the above mentioned example, the first page of content may comprise “page 10” within the current storyline. Conversely, if the differential time, instant time, or average reading time is not within the threshold value or range, a second new page of content may be displayed, which is different than the first new page of content. For example, the second new page of content may comprise the beginning of an alternative storyline that is different than the current storyline, for example “alternate page 10.” Once the appropriate page of content is displayed to the user, the processing routine 500 can proceed to step 508 where the processing routine 500 awaits a request for new content.

If the examined page of content does not contain any rules, the processing system 21 can proceed to step 507 where the retrieved page of content is displayed. Once the content is displayed, the processing system 21 can proceed to step 508 to await a request for new content. For example, the processing system 21 can wait for the user to select the next page of content to be displayed. This may be the case when the processing system 21 simply waits for the user to turn the page of the e-book 26 in step 508. Upon the user selecting the next page of content to be displayed, the processing routine 500 can return to step 505.

The processing routine 500 may end upon a user closing the e-book 26. According to another embodiment, the processing routine 500 may end upon a user finishing the e-book, i.e., the user reaching the last page of a storyline.

It should be appreciated that while the above processing routine 500 determines if each page of content contains a rule, in other embodiments, only certain pages of content may be examined for rules. For example, in some embodiments, the first and/or last pages of a chapter may be checked for rules to be processed while other pages within a chapter are not examined. Therefore, the processing routine 500 should not be limited to requiring the processing system 21 to determine if every page of the e-book includes a rule.

The embodiments described above provide an e-book 26 comprising more than one storyline. The e-book 26 has one or more time-based rules, which control an order of content that is displayed to a user. The embodiments described above further provide an e-book reader 20 that is capable of processing the time-based rules associated with the e-book 26 to selectively display various pages of content based on the outcome of processed rules. Advantageously, the embodiments described above can provide a user with an improved reading experience that can change based on the results of various processed time-based rules.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other electronic books, and not just to the embodiments described above and shown in the accompanying figures. Accordingly, the scope of the embodiments described above should be determined from the following claims.

We claim:

1. An electronic book, comprising:
a first storyline and at least a second storyline; and
one or more time-based rules, which control an order of content displayed to a user from the first storyline or the at least second storyline.

2. The electronic book of claim 1, wherein the one or more time-based rules are embedded at predetermined locations in the first and at least second storylines.

3. The electronic book of claim 1, wherein a time-based rule of the one or more time-based rules comprises:
a start marking point to begin tracking time; and
an injection point to end tracking time and process the time-based rule.

4. The electronic book of claim 3, wherein the time-based rule is based on an absolute differential time between the start marking point and the injection point.

5. The electronic book of claim 3, wherein the time-based rule is based on an average reading time between the start marking point and the injection point.

6. The electronic book of claim 1, wherein the time-based rule is based on an instant time.

7. The electronic book of claim 1, further comprising one or more exceptions that can prevent processing of the one or more time-based rules.

8. A method for defining content of an electronic book to be displayed, comprising:
determining if a page of content includes a time-based rule;
if the page of content does include a time-based rule, process the time-based rule; and
defining a page of content to be displayed based on the outcome of the processed time-based rule.

9. The method of claim 8, wherein the page of content to be displayed comprises the same page of content including the time-based rule.

10. The method of claim 8, wherein the page of content to be displayed comprises a page different from the page of content including the time-based rule.

11. The method of claim 8, wherein processing the time-based rule comprises:
determining an absolute differential time between two pages of content; and
comparing the determined absolute differential time to a threshold value or range.

12. The method of claim 11, wherein a first new page of content is defined if the determined absolute differential time is within the threshold value or range or a second new page of content is defined if the determined absolute differential time exceeds the threshold value or range.

13. The method of claim 12, wherein the first new page corresponds to a next logical page of a current storyline and the second new page corresponds to a next logical page of an alternative storyline.

14. The method of claim 8, wherein processing the time-based rule comprises:
determining an instant time; and
comparing the instant time to a threshold value or range.

15. The method of claim 14, wherein a first new page of content is defined if the determined instant time is within the threshold value or range and a second new page of content is defined if the determined instant time exceeds the threshold value or range.

16. The method of claim 15, wherein the first new page corresponds to a next logical page of a current storyline and the second new page corresponds to a next logical page of an alternative storyline.

17. The method of claim 8, wherein processing the time-based rule comprises:
determining an average reading time; and
comparing the average reading time to a threshold value or range.

18. The method of claim 17, wherein the average reading time is determined from a group comprising: a user input, an assumed reading time based on one or more of the user's characteristics, an assumed reading time based on an intended reading audience of the electronic book, and a calculated reading time based a time for a user to turn a page of the electronic book.

19. The method of claim 17, wherein a first new page of content is defined if the determined average reading time is within the threshold value or range or a second new page of content is defined if the determined average reading time exceeds the threshold value or range.

20. The method of claim 19, wherein the first new page corresponds to a next logical page of a current storyline and the second new page corresponds to a next logical page of an alternative storyline.

21. A software application stored in a non-transitory medium for defining content of an electronic book to be displayed and configured to:
determine if a page of content includes a time-based rule;
if the page of content does include a time-based rule, process the time-based rule; and
define a page of content to be displayed based on the outcome of the processed time-based rule.

22. The software application of claim 21, wherein the page of content to be displayed comprises the same page of content including the time-based rule.

23. The software application of claim 21, wherein the page of content to be displayed comprises a page different from the page of content including the time-based rule.

24. The software application of claim 21, further configured to:
determine an absolute differential time between two pages of content; and
compare the determined absolute differential time to a threshold value or range.

25. The software application of claim 24, wherein a first new page of content is defined if the determined absolute differential time is within the threshold value or range or a second new page of content is defined if the determined absolute differential time exceeds the threshold value or range.

26. The software application of claim 25, wherein the first new page corresponds to a next logical page of a current storyline and the second new page corresponds to a next logical page of an alternative storyline.

27. The software application of claim 21, further configured to:
determine an instant time; and
compare the instant time to a threshold value or range.

28. The software application of claim 27, wherein a first new page of content is defined if the determined instant time is within the threshold value or range and a second new page of content is defined if the determined instant time exceeds the threshold value or range.

29. The software application of claim 28, wherein the first new page corresponds to a next logical page of a current storyline and the second new page corresponds to a next logical page of an alternative storyline.

30. The software application of claim 21, further configured to:
determine an average reading time; and
compare the average reading time to a threshold value or range.

31. The software application of claim 30, wherein the average reading time is determined from a group comprising: a user input, an assumed reading time based on one or more of the user's characteristics, an assumed reading time based on an intended reading audience of the electronic book, and a calculated reading time based a time for a user to turn a page of the electronic book.

32. The software application of claim 30, wherein a first new page of content is defined if the determined average reading time is within the threshold value or range or a second new page of content is defined if the determined average reading time exceeds the threshold value or range.

33. The software application of claim 32, wherein the first new page corresponds to a next logical page of a current storyline and the second new page corresponds to a next logical page of an alternative storyline.

34. An electronic book reader, comprising:
an interface;
a storage system including at least one electronic book and a software application for processing one or more time-based rules for the at least one electronic book; and
a processing system configured to process the one or more time-based rules and display content of the at least one electronic book.

35. The electronic book reader of claim 34, wherein the processing system is further configured to:
determine if a page of content includes a time-based rule;
process the time-based rule if the page of content includes the time-based rule; and
display a page of content on the interface based on the outcome of the processed time-based rule.

36. The electronic book reader of claim 34, wherein the page of displayed content comprises the same page of content including the time-based rule.

37. The electronic book reader of claim 34, wherein the page of displayed content comprises a page different from the page of content including the time-based rule.

38. The electronic book reader of claim 34, wherein the processing system is further configured to:
determine an absolute differential time between two pages of displayed content; and
compare the determined absolute differential time to a threshold value or range.

39. The electronic book reader of claim 38, wherein a first new page of content is displayed on the interface if the determined absolute differential time is within the threshold value or range or a second new page of content is displayed on the interface if the determined absolute differential time exceeds the threshold value or range.

40. The electronic book reader of claim 39, wherein the first new page corresponds to a next logical page of a current storyline and the second new page corresponds to a next logical page of an alternative storyline.

41. The electronic book reader of claim 34, wherein the processing system is further configured to:
determine an instant time; and
compare the instant time to a threshold value or range.

42. The electronic book reader of claim 41, wherein a first new page of content is defined if the determined instant time is within the threshold value or range and a second new page of content is defined if the determined instant time exceeds the threshold value or range.

43. The electronic book reader of claim 42, wherein the first new page corresponds to a next logical page of a current storyline and the second new page corresponds to a next logical page of an alternative storyline.

44. The electronic book reader of claim 34, wherein the processing system is further configured to:
determine an average reading time; and
compare the average reading time to a threshold value or range.

45. The electronic book reader of claim 44, wherein the average reading time is determined from a group comprising: a user input, an assumed reading time based on one or more of the user's characteristics, an assumed reading time based on an intended reading audience of the electronic book, and a calculated reading time based a time for a user to turn a page of the electronic book.

46. The electronic book reader of claim 44, wherein the processing system is further configured to display a first new page of content if the determined average reading time is within the threshold value or range and display a second new page of content if the determined average reading time exceeds the threshold value or range.

47. The electronic book reader of claim 46, wherein the first new page corresponds to a next logical page of a current storyline and the second new page corresponds to a next logical page of an alternative storyline.

48. A method for incorporating one or more time-based rules into an electronic book, comprising:
retrieving an electronic book file;
inserting a rule start marking point for a time-based rule in the electronic book file; and
inserting a rule injection point for the time-based rule in the electronic book file.

49. The method of claim 48, wherein the time-based rule is based on an absolute differential time between the start marking point location and the injection point location.

50. The method of claim 49, further comprising:
instructing a first page of content of the electronic book to be displayed if the absolute time between the start marking point location and the injection point location is within a threshold value or range; and
instructing a second page of content to be displayed if the absolute time between the start marking point location and the injection point location is outside the threshold value or range.

51. The method of claim 50, wherein the first page of content comprises a first storyline and the second page of content comprises a second storyline.

52. The method of claim 48, wherein the time-based rule is based on an instant time.

53. The method of claim 52, further comprising:
instructing a first page of content of the electronic book to be displayed if the instant time is within a threshold value or range; and
instructing a second page of content to be displayed if the instant time is outside the threshold value or range.

54. The method of claim 53, wherein the first page of content comprises a first storyline and the second page of content comprises a second storyline.

55. The method of claim 48, wherein the time-based rule is based on an average reading time between the start marking point location and the injection point location.

56. The method of claim 55, wherein the determined course of action comprises:
instructing a first page of content of the electronic book to be displayed if the average reading time between the start marking point location and the injection point location is within a threshold value or range; and
instructing a second page of content to be displayed if the average reading time between the start marking point location and the injection point location is outside the threshold value or range.

57. The method of claim 56, wherein the first page of content comprises a first storyline and the second page of content comprises a second storyline.
